(19) United States
(12) Patent Application Publication
(10) Pub. No.: US 2024/0324521 A1
(43) Pub. Date: Oct. 3, 2024

(54) CONTAINER HAVING AN AIRFLOW CHANNEL

(71) Applicant: Paul L. COTE, Knowlton (CA)

(72) Inventor: Paul L. COTE, Knowlton (CA)

(21) Appl. No.: 18/619,993

(22) Filed: Mar. 28, 2024

Related U.S. Application Data
(60) Provisional application No. 63/456,059, filed on Mar. 31, 2023.

(51) Int. Cl. A01G 9/02; A01G 27/00

(52) U.S. Cl. CPC A01G 9/024; A01G 27/008

(57) ABSTRACT

The present disclosure provides a container having an outer pot, inner sieve removably positioned in the outer pot and a saucer secured to the outer pot. Placement of the inner sieve within the outer pot creates a channel through which air can flow and better aerate and therefore prune plant roots. In turn, the pruning will promote growth of new branching roots from the center of the root system. Further, water contained in the saucer provides a capillary effect to hydrate the plant and growing medium. Alternatively, the container defines an inner sieve removeable positioned in an outer pot without the saucer, the sieve and pot defining a channel through which air can flow. The channel is defined as air flowing from lower portion of the container to an upper portion of the container.

### CROSS REFERENCE TO RELATED APPLICATION

The present application claims priority to U.S. Provisional Application No. 63/456,059, entitled “CONTAINER HAVING AIRFLOW CHANNEL” filed on Mar. 31, 2023, the contents of which are incorporated herein by reference in their entirety.

### FIELD

The disclosure relates to the field of home and gardening, and more specifically to a container having an airflow channel.

### BACKGROUND

Proper aeration and hydration have been shown to be critical for optimal plant growth. As such, it is essential that a container or pot to hold a plant have at least some drainage holes. Newer containers have had added drainage and aeration holes to better help with plant growth.

More specifically, Korean Patent No. KR200320283 describes a container having an inner and outer lining, the inner lining having drainage holes and the outer lining connected to a water container to feed water in the lower portion. However, water only travels upwardly from the stagnant water pool out of holes in between the linings. Meanwhile, Korean Patent No. KR100794260 similarly describes a container having inner and outer linings, the inner lining perforated with holes and the outer lining having a drainage hole at the bottom so that air can come up from the lower end of the outer lining and through a channel to the top. However, here there is no water that can accumulate in the lower end of the outer lining and it requires a ventilation means. U.S. Pat. No. 5,852,289 (Flasch) also describes a container having inner and outer linings; however, there is only an aperture at the top in between the linings to provide airflow to this area. Finally, U.S. Pat. No. 5,934,017 (Ho) describes a complicated container having a water reservoir, the container including a fan to force air from pooled water in the area in between the inner and outer linings. However, this device is cumbersome and complicated, requiring many parts to properly aerate plant roots and only uses the stale air and not fresh air.

When a plant root tip comes into contact with air it dries and dies. This process is called root pruning. The growth of the root is stopped or pruned. The plant then produces new branching roots from the center of the root system, creating a healthier and stronger root ball and a healthier plant. Healthier plants grow better fruit or flowers, are more disease resistant, there is less transplant shock and susceptibility to root rot or disease.

As such, there is a device needed to overcome the shortcomings of this prior art and utilize air pruning techniques; namely, a container that can receive fresh air from a lower portion of the container, and have this air flow through a channel created in between the inner and outer linings. This airflow will prune the roots that are exposed in this air channel, which will in turn promote new root growth from the main stem of the plant and optimize plant health and growth. This improved container may allow water to pool at the bottom in a lower section thereof, to provide a capillary (i.e. wicking) effect of the roots and soil drawing water as needed to better feed the plant when it requires hydration. The addition of the channel also protects the outer wall of the sieve—from wind, evaporation and ambient air, which promotes natural hydration of the root system.

### SUMMARY

In an aspect, the present disclosure provides a container comprising: an outer pot; and, an inner sieve removably positioned in the outer pot, the inner sieve to contain plants and growing medium, wherein the outer pot and inner sieve define a channel through which air can flow to aerate roots of the plants and growing medium.

In another aspect, the present disclosure provides a container comprising: an outer pot; an inner sieve removably positioned in the outer pot, the inner sieve to contain plants and growing medium; and, a saucer connected to one of: the outer pot and the inner sieve, the saucer to contain water, wherein the outer pot, inner sieve and saucer define a channel through which air can flow to prune roots of the plant and growing medium.

In yet another aspect, the present disclosure provides for a modular hanger for use with a container, the modular hanger comprising: a hook portion to hang the modular hanger; a plurality of lines extending from the hook portion; and, a latch extending from a tip of the plurality of lines to secure the modular hanger to the container.

### BRIEF DESCRIPTION OF THE DRAWINGS

The following figures serve to illustrate various embodiments of features of the disclosure. These figures are illustrative and are not intended to be limiting.

FIG. 1 is a perspective view of a container having an airflow channel, according to an embodiment of the present disclosure;

FIG. 2 is an underside perspective view of an inner sieve of the container of FIG. 1, according to an embodiment of the present disclosure;

FIG. 3 is an underside perspective view of an outer pot of the container of FIG. 1, according to an embodiment of the present disclosure;

FIG. 4 is a perspective view of the outer pot of the container of FIG. 1, according to an embodiment of the present disclosure;

FIG. 5 is a perspective view of a saucer of the container of FIG. 1, according to an embodiment of the present disclosure;

FIG. 6 is a front cross-sectional view of the container of FIG. 1 along the lines “FIG. 6-FIG. 6”, according to an embodiment of the present disclosure;

FIG. 7 is a front cross-sectional view of the container of FIG. 1 along the lines “FIG. 7-FIG. 7”, according to an embodiment of the present disclosure;

FIG. 8 is an underside perspective cross-sectional view of the container of FIG. 7 illustrating an airflow, according to an embodiment of the present disclosure;

FIG. 9 is an underside perspective cross-sectional view of a container without a central column, according to another embodiment of the present disclosure;

FIG. 9A is a perspective view of a saucer of the container of FIG. 9, according to another embodiment of the present disclosure;

FIG. 10 is a perspective view of a container having an airflow channel, the container without a central column and having securing openings to secure a hanger, according to another embodiment of the present disclosure;

FIG. 11 is an underside perspective view of an inner sieve for a container, according to another embodiment of the present disclosure;

FIG. 12 is an underside perspective cross-sectional view of the container of FIG. 10 along the lines “FIG. 12-FIG. 12” illustrating an airflow, according to an embodiment of the present disclosure;

FIG. 13 is an underside perspective cross-sectional view of a container illustrating an airflow, according to another embodiment of the present disclosure;

FIG. 14 is a front cross-sectional view of the container of FIG. 13, according to another embodiment of the present disclosure;

FIG. 15 is a perspective view of a container to yet another having an airflow channel, according embodiment of the present disclosure;

FIG. 16 is a perspective view of a saucer of the container of FIG. 15, according to an embodiment of the present disclosure;

FIG. 17 is an enlarged cross-sectional view of an inner sieve, outer pot and saucer of the container of FIG. 15, according to an embodiment of the present disclosure;

FIG. 18 is an enlarged cross-sectional view of the base of the inner sieve of the container of FIG. 15, according to an embodiment of the present disclosure;

FIG. 19 is an enlarged view of a float in a casing of the container of FIG. 15, according to an embodiment of the present disclosure;

FIG. 20 is prior art of a hanger for a container;

FIG. 21 is a perspective view of an improved hanger of the container of FIG. 15, according to an embodiment of the present disclosure;

FIG. 22 is an enlarged cross-sectional view of a hook portion of the hanger of FIG. 21, according to an embodiment of the present disclosure; and,

FIG. 23 is an enlarged cross-sectional view of a latch secured to an outer pot of the container of FIG. 15, according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

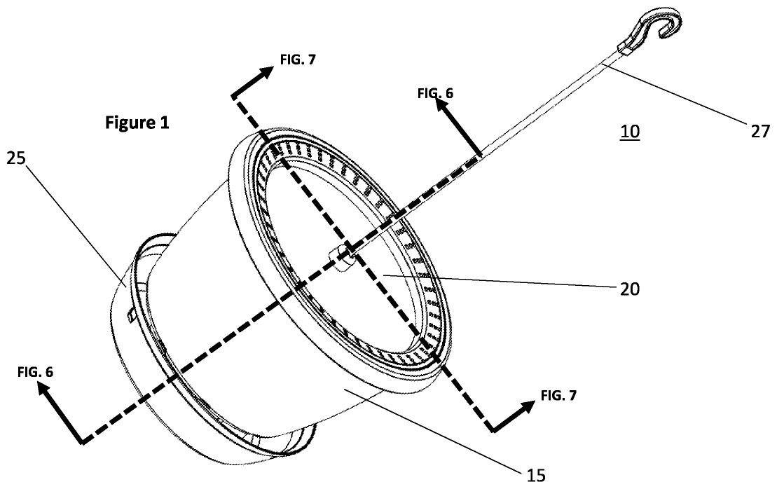

With reference to FIG. 1 and according to an embodiment of the present disclosure, a container 10 is shown, the container 10 comprising an outer pot 15, an inner sieve 20 removably positioned in the outer pot 15, the inner sieve 20 to contain growing medium and plants, and an optional saucer 25 connected to the outer pot 15, the saucer 25 to contain water. In this embodiment, the outer pot 15, inner sieve 20 and saucer 25 define a channel (not shown) through which air can flow to naturally prune the exposed roots of the plant. The container 10 is also comprised of an optional hanger 27 to hang the container 10 from a hook. Although the inner sieve 20 may typically contain plants, it may also contain other growing medium without departing from the scope of the disclosure.

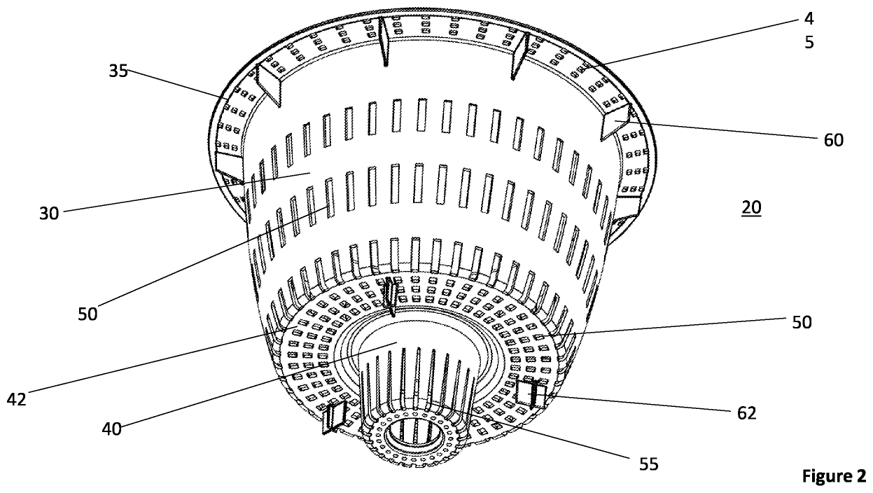

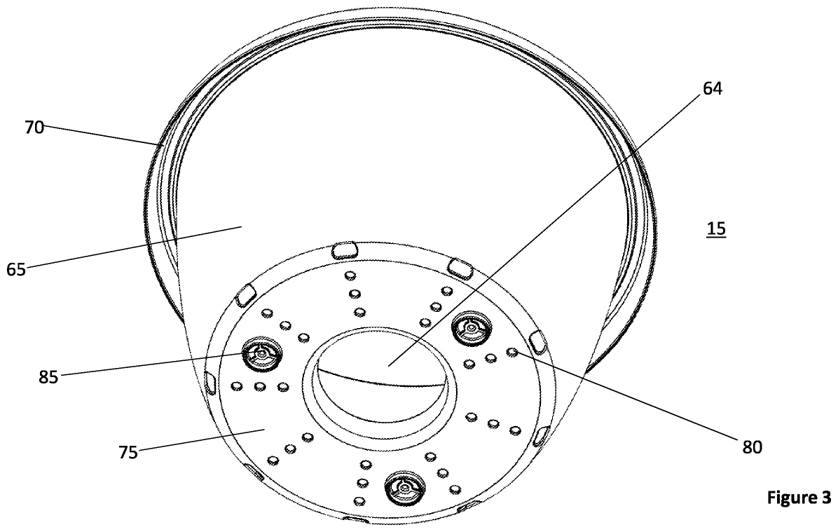

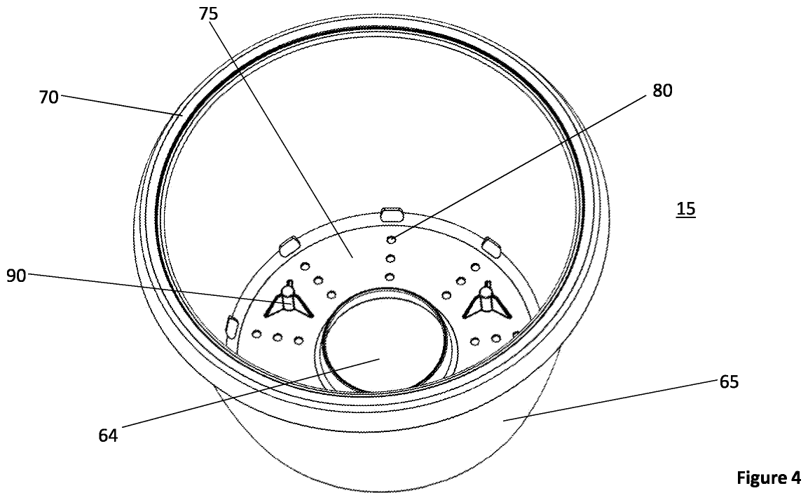

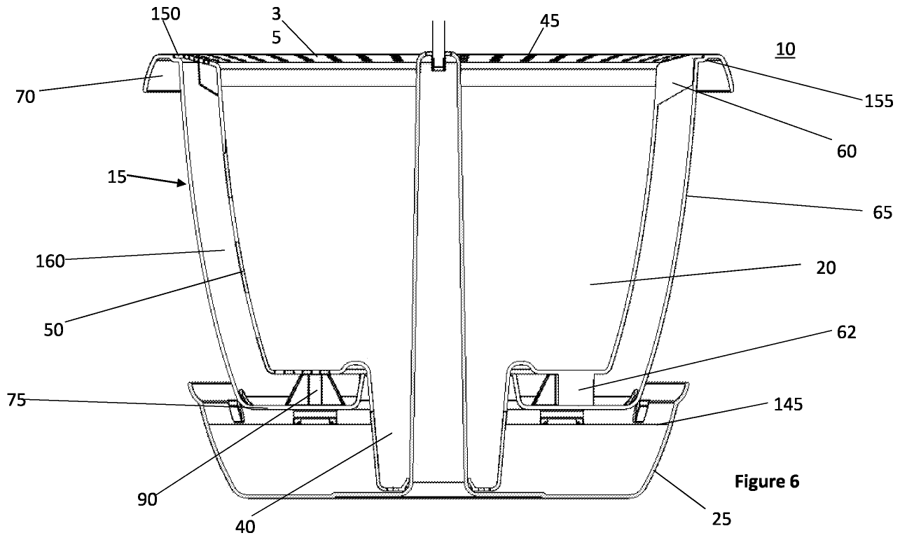

With reference to FIGS. 2, 3 and 4, the inner sieve 20 is shown comprised of a central body 30 having a rim 35 at an upper end, and a lower body 40 projecting downwardly from an underside 42 of the central body 30. The rim 35 is further comprised of a plurality of apertures 45 to provide exhaust of warm air from the channel (not shown). The central body 30 and underside 42 are comprised of holes 50 through which the root system of the plant will escape into the channel (not shown). The lower body 40 has openings 55 to allow lower roots, as well as roots and soil contained in the lower body 40, to come into contact with water accumulated in the saucer (not shown). Indeed, the lower body 40 will sit and bathe in the saucer (not shown), as best shown in FIGS. 6-9, and therefore allow pooled water to soak the earth and roots in the lower body 40. It is an object of the present disclosure that an operator of the container 10 could also add water in the saucer (not shown) to provide additional nutrients to the roots or other growing medium. These roots and other growing medium can then transport water easily up the plant through the capillary effect. The rim 35 is comprised of upper slats 60 and the lower body 40 is comprised of lower slats 62. The upper slats 60 project downwardly from the rim 35 and outwardly from the central body 30. Together, the upper and lower slats 60, 62 cooperate with the outer pot 15 to provide separation between the inner sieve 20 and the outer pot 15 when the inner sieve 20 is positioned within the outer pot 15. The lower body 40 projects downwardly from the underside 42 of the central body 30, the lower body 40 being generally cylindrically-shaped and having a diameter (or width) that is smaller the width or diameter of the central body 30. The lower body 40 is adapted to fit into an opening 64 of the outer pot 15. The outer pot 15 is comprised of a central body 65 having a rim 70 at an upper end, the central body 65 also having a base 75. The base 75 of the outer pot 15 is further comprised of venting holes 80 to help with both water drainage and airflow. The base 75 of the outer pot 15 is also comprised of alignment members 85 to align with the saucer (not shown) and receive a nail (not shown) or other fastening means. The alignment members 85 have projections 90 projecting upwardly from the base 75 to receive the length of the nail and secure the outer pot 15 to the saucer (not shown). As noted, the base 75 is also comprised of an opening 64 to receive the lower body 40 of the inner sieve 20 to properly align the outer pot 15 with the inner sieve 20.

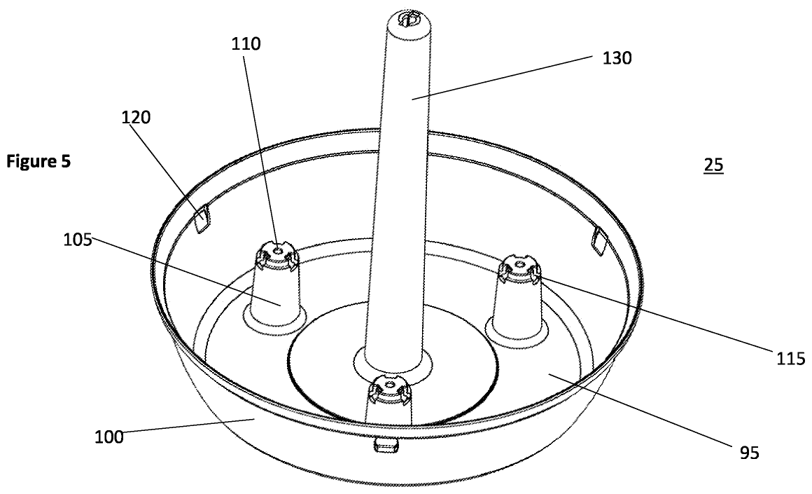

With reference to FIG. 5 and according to an embodiment of the present disclosure, the saucer 25 has a base 95 and a circumferential wall 100 to receive water. This water would feed the roots or other growing medium contained in the lower end of the sieve (not shown). A plurality of posts 105 project upwardly from the base 95 of the saucer 25, the posts 105 terminating in a stepped portion 110 to receive alignment members (not shown) of the outer pot (not shown). Each of the stepped portions 110 of the posts 105 have openings 115 adapted to allow excess water in the saucer 25 to escape. The saucer 25 also has peripheral evacuation holes 120 positioned on the circumferential wall 100 to similarly allow excess water in the saucer 25 to escape. A worker skilled in the art would appreciate that although a plurality of openings 115 or evacuation holes 120 are shown, only one such aperture is required to allow excess water to escape. The saucer 25 is also comprised of a central column 130 projecting from the base 95 of the saucer 25, the central column 130 adapted to receive the hanger (not shown) to hang the container. Operationally, the saucer 25 will receive water that may have drained from the sieve (not shown) and outer pot (not shown), or that was added by a user. Some of the lower roots of the plant will come into contact with this additional water supply to create a capillary effect and bring water back up to the plant as needed (e.g. when moisture in the earth is reduced). In an optional embodiment, there may be a float in the water to monitor the water level.

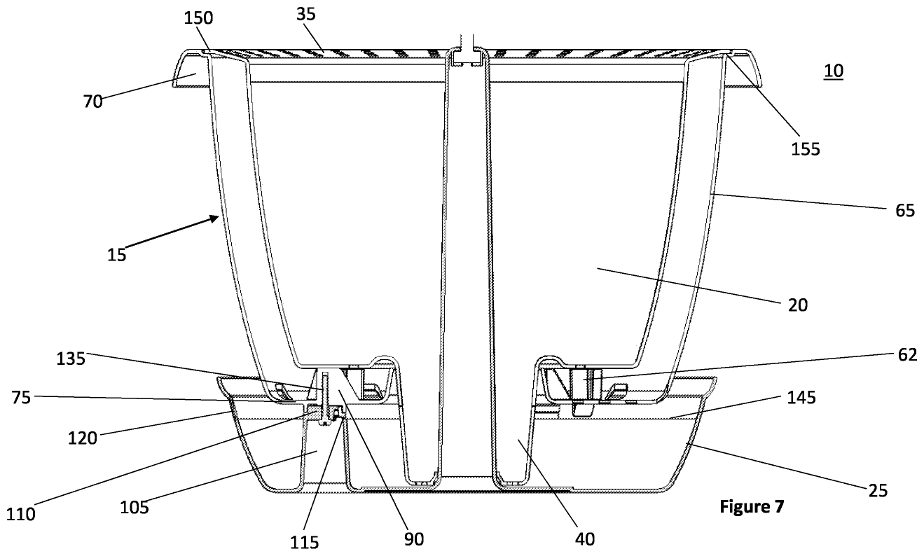

With reference to FIGS. 6 and 7 and according to an embodiment of the present embodiment, the container 10 is shown in greater detail. To assemble the container 10, the alignment members (not shown) of the outer pot 15 are aligned and positioned over the posts 105 and stepped portions 110 of the saucer 25. In this embodiment, a nail 135 or other fastening means is screwed through the stepped portion 110 and into the projections 90 of the outer pot 15. A worker skilled in the art would appreciate that although a nail 135 is used, the outer pot 15 may be positioned into the saucer 25 without being fastened thereto. In another embodiment, a worker skilled in the art would appreciate that the saucer 25 does not need to be secured to the outer pot 15 and may instead be unsecured or removeably connected to the outer pot 15 or even to the inner sieve 20. Once the outer pot 15 is positioned over the saucer 25, excess water in the container 10 that flows into the saucer 25 can escape by means of openings 115 or evacuation holes 120. In FIGS. 6 and 7, the maximum water line 145 is shown. After the outer pot 15 is positioned into and connected to the saucer 25, the removable inner sieve 20 can be positioned into the outer pot 15. The inner sieve 20 is aligned with the outer pot 15 by centering the lower body 40 within the opening (not shown) of the outer pot 15. The inner sieve 20 is then lowered into the outer pot 15 until the lower slats 62 are flush the base 75 of the outer pot 15. At this time, the upper slats 60 will come into contact and be flush with the central body 65 of the outer pot 15. Together with the lower body 40, the upper slats 60 ensure that the inner sieve 20 is properly aligned with the outer pot 15 and saucer 25. In an optional embodiment, once the inner sieve 20 is set within the outer pot 15, a peripheral edge 150 of the rim 35 of the inner sieve 20 will sit in a stepped portion 155 of the rim 70 of the outer pot 15.

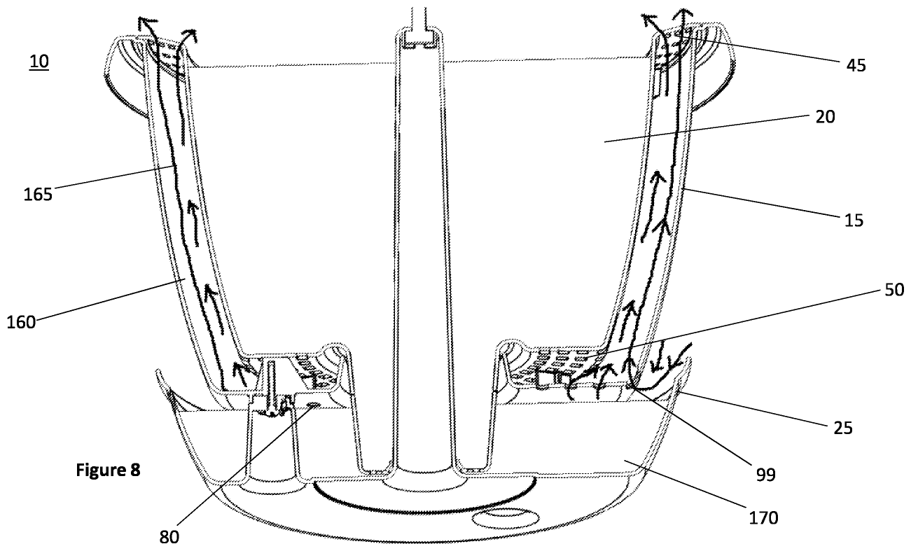

With reference to FIGS. 6 and 8 and according to an embodiment of the present disclosure, the container 10 is shown, the container 10 defining a channel 160 through which air can flow. The channel 160 is defined as the area in between the inner sieve 20 and the outer pot 15, including below and around the circumference of the inner sieve 20. Arrows 165 are positioned going into the channel 160 and out of the container 10, the arrows 165 representing airflow in and through the channel 160. As shown, fresh cooler air from a lower portion of the container 10 can move into the saucer 25 and above the water 170. This cooler air enters the channel 160 through the venting holes 80 and lower vents 98 of the container 15. A worker skilled in the art would appreciate that roots from the plant escape through the holes 50 and into the channel as the plant grows. Accordingly, the airflow in the channel 160 dries up the roots (i.e. air pruning), which forces the plant to sprout new, branching roots. The airflow in channel 160 can escape the channel 160 by apertures 45 in the rim 35 of the inner sieve 20. A worker skilled in the art would appreciate that in another embodiment, the rim 35 may not have apertures, and instead the upper portion of the outer pot 15 would have such apertures to allow airflow to escape from an upper area of the container 10. In yet another embodiment, the container 15 may not have venting holes 99. Indeed, what is important is that the channel 160 be preferably formed from a lower portion of the container 10 to an upper portion of the container 10, to provide airflow to the roots of the plant, which in turn prunes them to promote further root growth in the root ball.

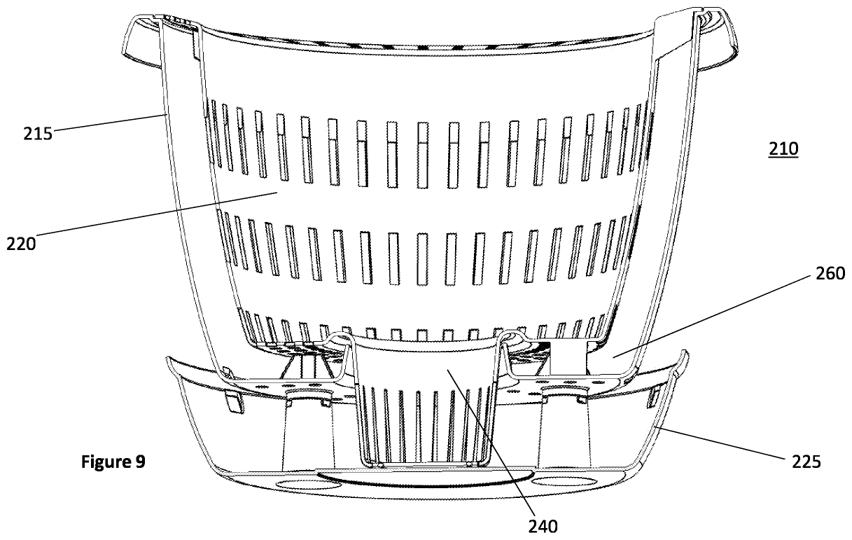

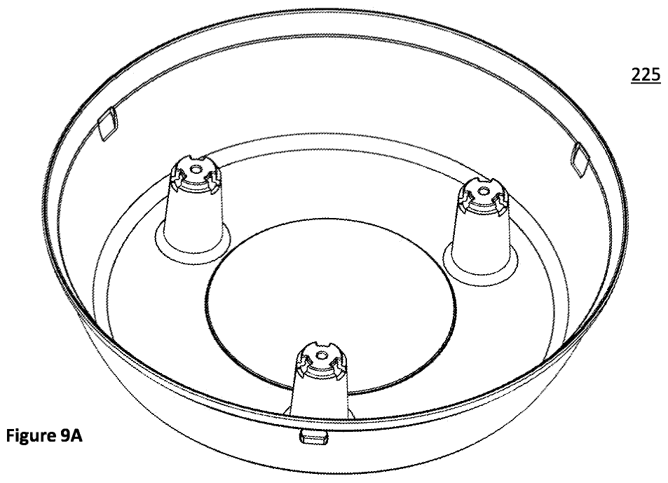

With reference to FIGS. 9 and 9A and according to another embodiment of the present disclosure, a container 210 is shown. In this alternate embodiment, the saucer 225 is not comprised of a central column and has a flat lower surface. The container 210 shown in FIG. 9 is preferably positioned on a surface and not hung. Similarly, the lower body 240 of the inner sieve 220 does not have an opening thereunder to receive the central column. The lower body 240 will sit in the saucer 225 and bathe in the water contained in the saucer 225. This will allow the roots and growing medium contained in the lower body 240 to soak in the water, and transport the water easily up the plant through the capillary effect. A channel 260 is still present in this embodiment, the channel 260 defined as the area in between the inner sieve 220 and the outer pot 215, including below and around the circumference of the inner sieve 220.

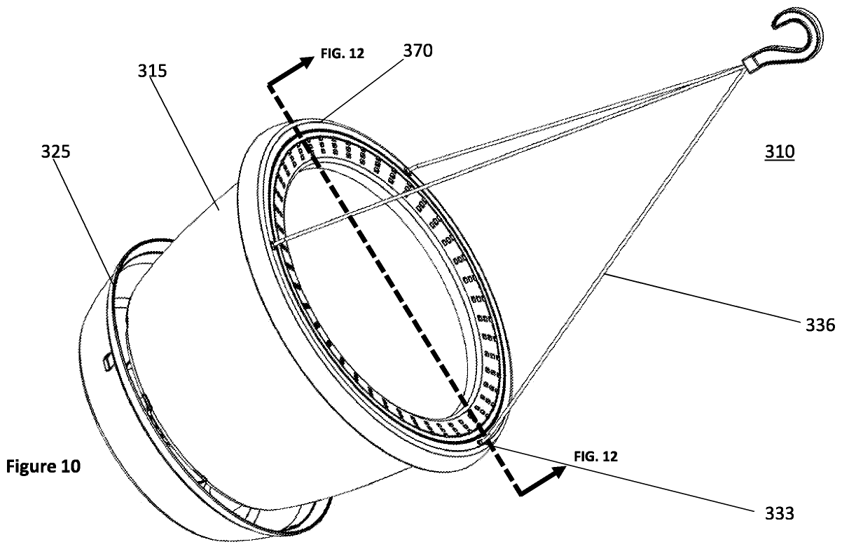

With reference to FIG. 10 and according to another embodiment of the present disclosure, a container 310 is shown, and the saucer 325 is similarly not comprised of a central column. In this embodiment, the rim 370 of the outer pot 315 is comprised of three securing openings 333 configured to receive hanger wires 336 to hang the container 310.

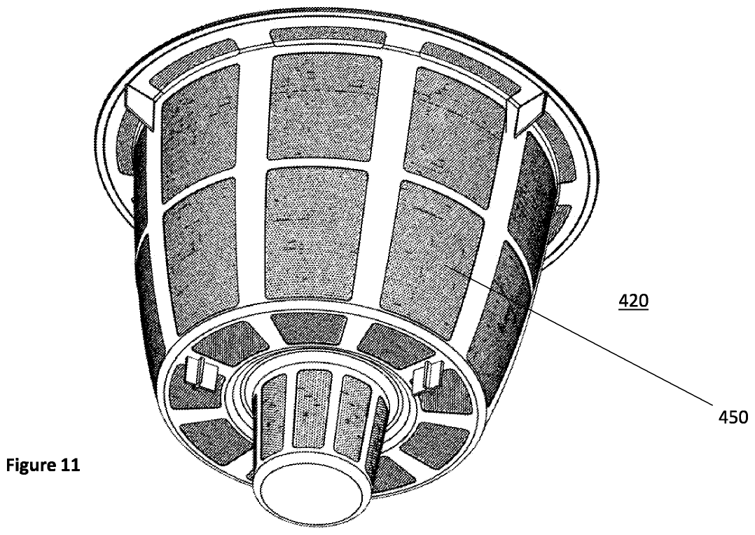

With reference to FIG. 11 and according to an embodiment of the present disclosure, a sieve 420 is shown. Instead of holes, the sieve 420 is comprised of openings having screens 450. The screens 450 serve to expose roots within the container (not shown) so that they are pruned. Indeed, the roots will abut the edge of the screens 450, which are exposed to air within the channel (not shown), and therefore prune the roots and promote better growth of the plant or growing medium.

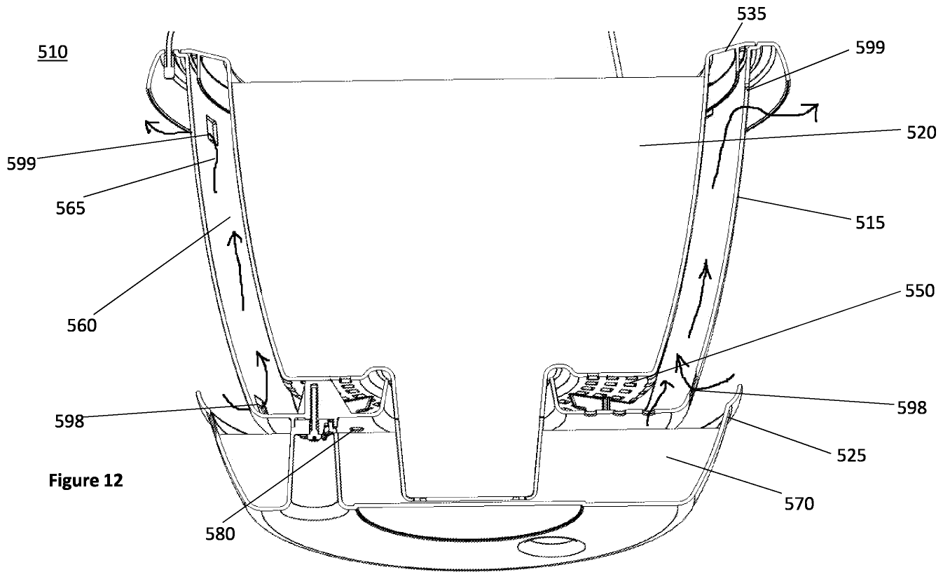

With reference to FIG. 12 and according to an embodiment of the present disclosure, a container 510 is shown defining a channel 560 through which air can flow. The channel 560 is circumferential and defined as the area in between the inner sieve 520 and the outer pot 515. Arrows 565 are positioned going into the channel 560 through a lower end of the container 510, and out of an upper end of the container 510, the arrows 565 representing airflow in and through the channel 560. As shown, fresh air from a lower portion of the container 510 can move into the saucer 525 and above the water 570. This fresh air moves through the channel 560, affecting the roots of the plant and pruning them to promote further growth of the plant with new roots branching off from the center of the root ball. In this alternate embodiment, the pot 515 is comprised of lower vents 598, that can receive air positioned outside and at a lower end of the container 510. Although only two lower vents 598 are shown, a worker skilled in the art would appreciate that a plurality of lower vents 598 are preferably positioned along the circumference of the outer pot 515. Air flows from the saucer 525, combining with the airflow from the lower vents 598 and travels through the channel 560 and escapes through upper vents 599 that are preferably positioned along the upper circumference of the outer pot 515. A worker skilled in the art would appreciate that roots from the plant escape through the holes (not shown) of the sieve 520 and into the channel 560 as the plant grows. Accordingly, the airflow in the channel 560 dries up the roots (i.e. air pruning), which forces the plant to sprout new, branching roots from the center of the root ball. Meanwhile, the lower roots of the plant will come into contact with pooled water 570 in the saucer 525 to create a capillary effect and bring water up to the top of the plant as needed (e.g. when moisture in the earth is reduced). A worker skilled in the art would appreciate that in another embodiment, upper vents 599 may not exist and instead be replaced with apertures (not shown) in the rim 535 of the sieve 520 to allow airflow to escape from the upper area of the container 510.

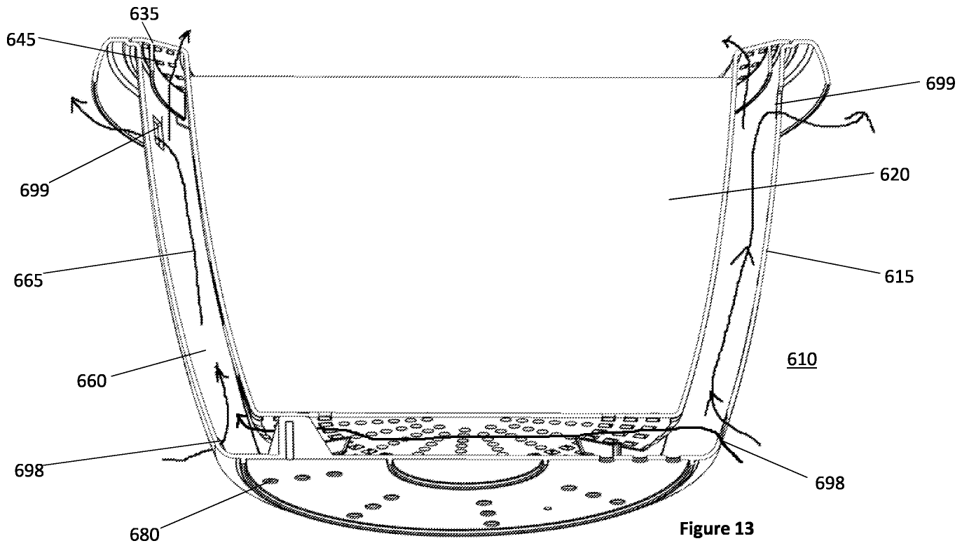

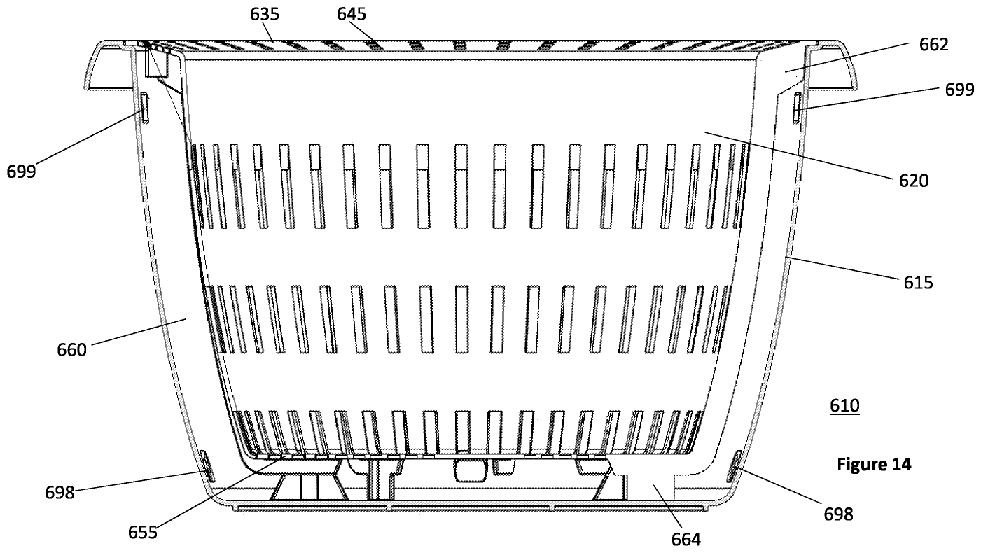

With reference to FIGS. 13 and 14 and according to another embodiment of the present disclosure, a container 610 is shown defining a channel 660 through which air can flow. The channel 660 is defined as the area in between the inner sieve 620 and the outer pot 615, including below and around the circumference of the inner sieve 620. Arrows 665 are positioned going into a lower end of the container 610, into the channel 660 and out of an upper end of the container 610, the arrows 665 representing airflow in, through and out of the channel 660. In this alternate embodiment, the saucer is absent, such that any excess water is expelled from drainage openings 655 and drainage holes 680. As no water pools to a saucer below, there is similarly no capillary effect in this container 610 and therefore no additional hydration provided to the plant. However, critically, the channel 660 is still present, such that fresh cool air from a lower portion of the container 610, moves through lower vents 698 of the outer pot 615 and into the channel 660. Although only two lower vents 698 are shown, a worker skilled in the art would appreciate that a plurality of lower vents 698 are preferably positioned along the circumference of the outer pot 615. Air travels through the channel 660 and escapes through upper vents 699 positioned along the upper circumference of the outer pot 615. Again, although only two upper vents 699 are shown, a worker skilled in the art would appreciate that a plurality of upper vents 699 are preferably positioned along the upper circumference of the outer pot 615. In this embodiment, air can also flow out of the channel 660 through apertures 645 positioned in the rim 635 of the sieve 620. During plant growth, roots from the plant escape through holes (not shown) of the sieve 620 and into the channel 660. Accordingly, the airflow in the channel 660 dries up the roots (i.e. air pruning), which forces the plant to sprout new, branching roots from the center of the root system. A worker skilled in the art would appreciate that in another embodiment, only one of the upper vents 699 or apertures 645 may exist, but in all instances, airflow would escape from an upper area of the channel 660 and container 610. The rim 635 is comprised of upper slats 662 and the lower body 40 is comprised of lower slats 664. Together, the upper and lower slats 662, 664 cooperate with the outer pot 615 to provide proper separation and alignment between the inner sieve 620 and the outer pot 615 when the inner sieve 620 is positioned within the outer pot 615. In this embodiment, excess water in the plant flows out of the inner sieve through drainage openings 655 and through drainage holes 680 of the outer pot 615.

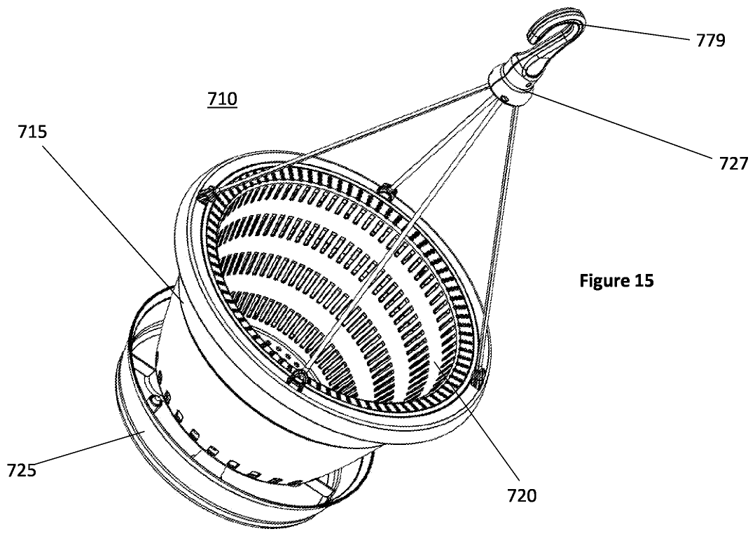

With reference to FIG. 15 and according to another embodiment of the present disclosure, a container 710 is shown, the container 710 comprising an outer pot 715, an inner sieve 720 removably positioned in the outer pot 715, the inner sieve 720 to contain growing medium and plants, and a saucer 725 connected to the outer pot 715, the saucer 725 to contain water. The outer pot 715, inner sieve 720 and saucer 725 define a channel (not shown) through which air can flow to naturally prune the exposed roots of the plant. The container 710 is also comprised of a modular hanger 727 to hang the container 710 from a hook portion 779.

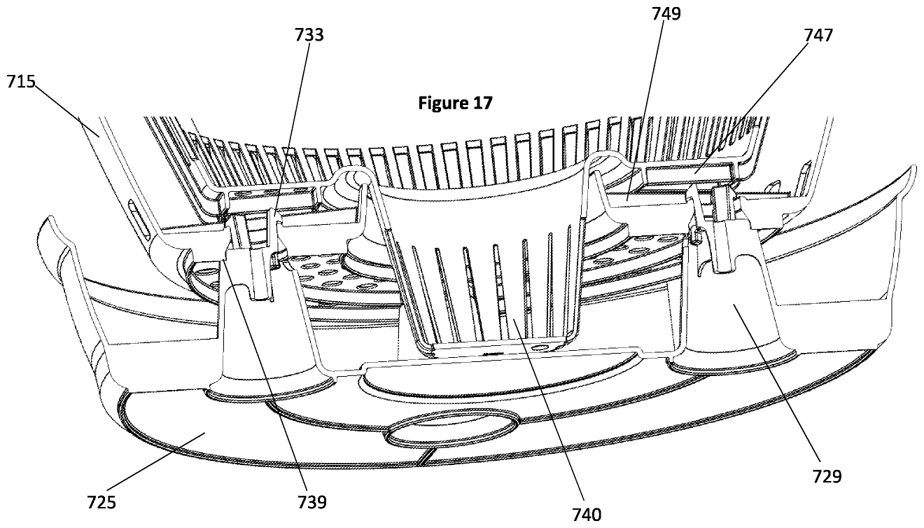

With reference to FIGS. 15, 16, 17 and 18 and according to another embodiment of the present disclosure, the saucer 725 is further comprised of posts 729 projecting from a base 731 of the saucer 725. The posts 729 terminate in clips 733, the clips 733 adapted for securing the saucer 725 to the outer pot 715. As shown, the clips 733 flare outwardly to align with receiving openings 737 of the outer pot 715. As shown, the receiving openings 737 have a funnel-like inner curvature to receive the clips 733 and self-center the posts 729 to the outer pot 715. The clips 733 are flexible, such that when the outer pot 715 is aligned with and pushed down on the saucer 725, the clips 733 flex and pivot inwardly along the funnel shape of the receiving openings 737 until the clips 733 lock into the base of the outer pot 715, as specifically shown in FIG. 17. The posts 729 are also comprised of a stepped portion 739 to receive a lip 741 of the outer pot 715 and therefore support the weight of the outer pot 715. Once the pot 715 and saucer 725 are secured to one another, the stepped portion 739 also prevents lateral movement of one relative to the other. The saucer 725 is further comprised of at least one rib 743 projecting from and extending along the base 731. A purpose of the rib 743 is to prevent undesired sloshing and other agitation of water within the saucer 725.

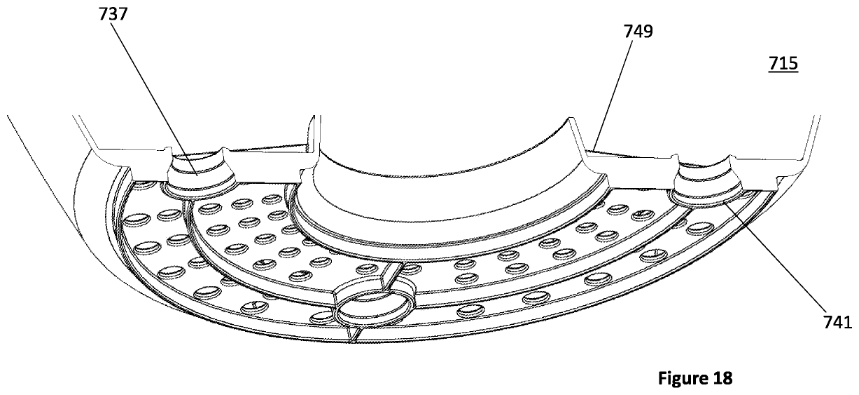

With further reference to FIGS. 17 and 18, it is an object of the present disclosure that the weight of the inner sieve 720 is supported by the outer pot 715. As such, the underside of the inner sieve 720 is comprised of spokes 747 to cooperate with corresponding beams 749 of the outer pot 715. In other words, the beams 749 of the outer pot 715 support the spokes 747 of the inner sieve 720, such that the lower body 740 of the inner sieve 720 preferably does not contact and is preferably not supported by the base 731 of the saucer 725, although not necessarily.

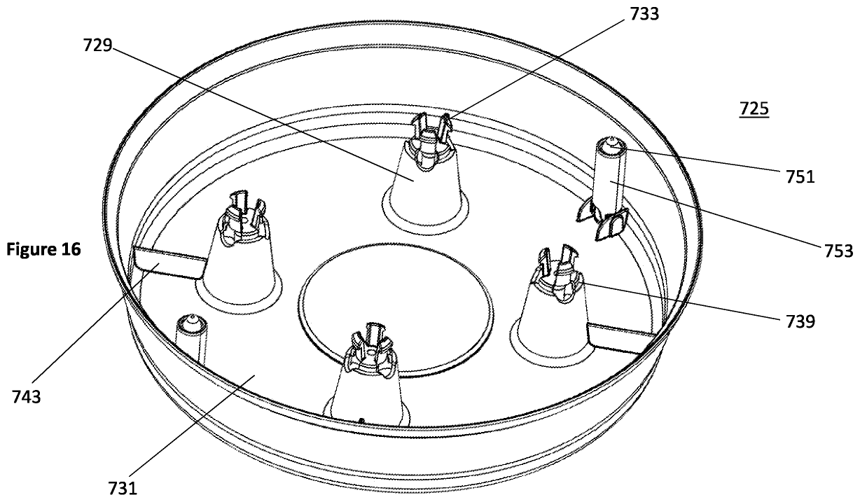

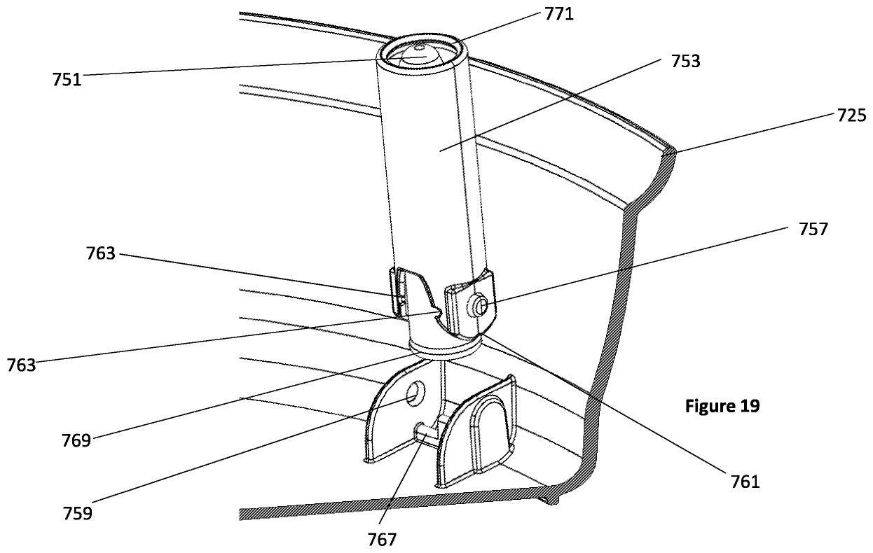

With reference to FIGS. 16, 17 and 19 and according to another embodiment of the present disclosure, the saucer 725 is further comprised of floats 751 contained within casings 753. The casing 753 is further comprised of dimples 757 configured to be positioned within cavities 759 of the saucer 725 that enable the casing 753 to pivot from an upright position (shown in FIGS. 16 and 19) to a flat position (not shown). The flat position is desirable for storage and shipping of the container. The casing 753 is also comprised of two lower notches 761 and two front notches 763. The notches 761, 763 are lockable into an arm 767 of the saucer 725, so that the casing 753 can be locked within either one of the flat or upright positions. The float 751 is further comprised of an annular flare-out 769 at a lower end thereof, the annular flare-out 769 to engage a corresponding annular flare-in 771 of the casing 753. During operation, when water is present in the saucer 725, the float 751 will rise up within the casing 753 to indicate a corresponding water level within the saucer 725. A worker skilled in the art would appreciate that the presently described saucer 725 could be utilized with a variety of containers. Indeed, in an alternate embodiment, the saucer 725 would not be comprised of posts 729 and have a flat base save for the pivotable casing 753 and float 751. A container having a smaller circumference than that of the saucer 725 could be positioned in the saucer 725, still allowing space for the casing 753 and float 751 to pivot. In yet another embodiment, the saucer 725 could be comprised of posts 729 without clips, to receive a container thereon without securing the container to the saucer 725, while still having the casing 753 and float 751. The pivotable casing 753 and float 751 could be positioned in a variety of saucers to allow for easy transportation of the saucer and ability to monitor water level.

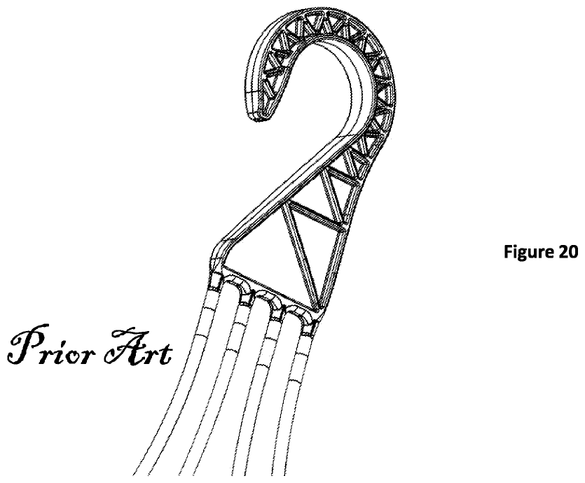

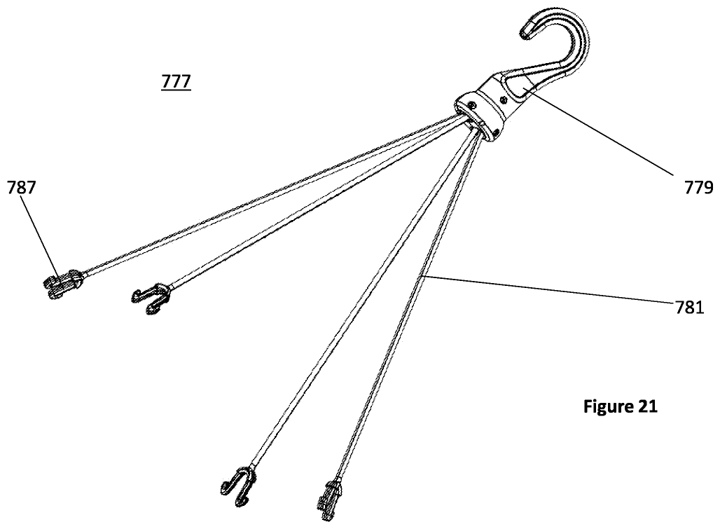

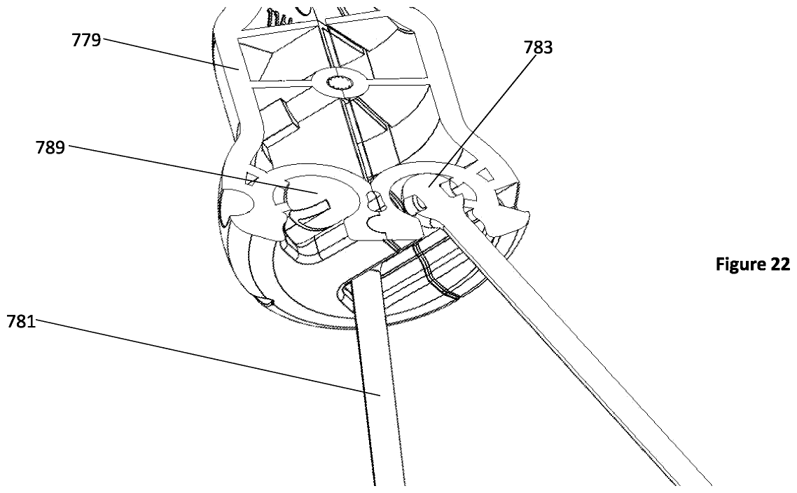

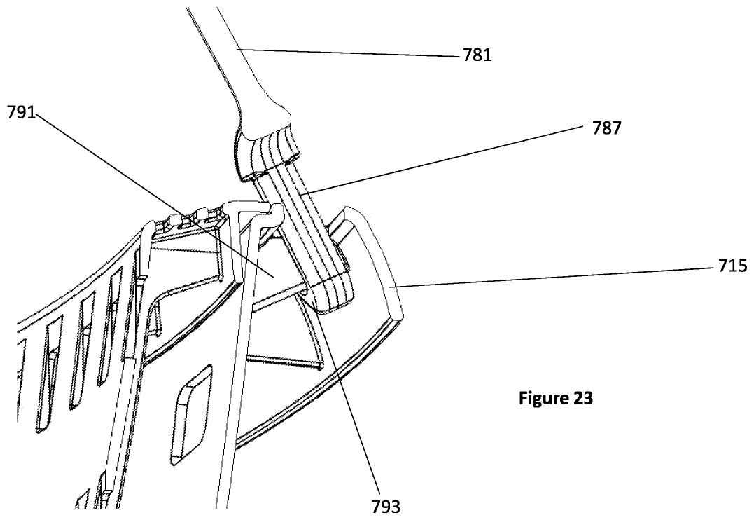

With reference to FIGS. 21, 22 and 23 and according to an embodiment of the present disclosure, an improved hanger 777 is shown. The hanger 777 is comprised of a hook portion 779 from which extends four lines 781, each line 781 having a ball joint 783 at one end and terminating in a U-shaped latch 787 at an opposed end. The hook portion 779 has a plurality of sockets 789 to receive the ball joints 783 of each line 781. The ball joints 783 allow the lines 781 to be pivotable with respect to the hook portion 779 and therefore accommodate a plurality of shapes and sizes of containers and also reduce angular stress and torsion of the line 781 on the hook portion 779. Indeed, a problem in the art for existing hangers is that the lines cannot rotate with respect to the hook portion, as shown in FIG. 20. As all the lines are positioned along the same axis of the hook portion of the prior art, torsion is created when the lines are twisted to the container, which is not a problem in the present design. Another advantage of the lines 781 having ball joints 783 is to allow for hanger 777 modularity. In other words, the lines 781 can be removed from the hook portion 779 if broken or worn. As shown, the lines 781 terminate in a latch 787, the latch 787 having a preferred U-shape configuration, each end of the “U” having a scoop 793 configured to latch into a corresponding angular member 791 positioned under the rim of the outer pot 715. By having such an angular member 791, the scoop 793 of the latch 787 is able to engage the angular member 791 at an optimal angle to reduces stress on the line 781. A worker skilled in the art would appreciate that the modular hanger 727 could be used with any container, including but not limited to the containers shown in FIGS. 1 and 10. In an alternate embodiment, the modular hander 727 could have the same ball joints 783 and socket 789 to allow a variety of angles of the lines 781, but be comprised of alternate latches 787 to latch into a variety of containers. For example, the latches 787 could be spheric members that have a corresponding opening and slit on the container, to insert the spheric member into the opening and slide into the slit to provide reduced stress on the lines 781.

With further reference to FIGS. 1, 9, 10, 12, 13 and 15, a worker skilled in the art would appreciate that a purpose of the outer pot is to protect the inner sieve from wind and other ambient conditions. It is undesirable to have such wind and other conditions directly affecting roots that have escaped from the inner sieve, as moisture is lost too quickly. In this manner, the channel created subjects the exposed root system to a controlled amount of air, which leads to optimal air pruning of those exposed roots and in turn optimal plant growth. For the embodiments specifically shown in FIGS. 1, 9, 10 and 12, the capillary (wicking) effect is also present, to allow the exposed lower roots and growing medium in the saucer to suck up water as needed for the plant and generate a stable level of hydration to maximize its growth.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A container comprising:
an outer pot; and,
an inner sieve removably positioned in the outer pot, the inner sieve to contain plants and growing medium,
wherein the outer pot and inner sieve define a channel through which air can flow to aerate roots of the plants and growing medium.

2. The container of claim 1 further comprising a saucer secured to the outer pot, the saucer to contain water.

3. The container of claim 1 further comprising a plurality of upper apertures positioned at an upper end of the channel and lower apertures positioned at a lower end of the channel, whereby air flows through the lower and upper apertures and into the channel.

4. The container of claim 3 wherein the lower apertures are positioned along at least one of: a circumferential wall of the outer pot and an underside of the outer pot; and the upper apertures are positioned along at least one of: the circumferential wall of the outer pot and a rim of the inner sieve.

5. The container of claim 3 wherein the channel is an area in between the inner sieve and the outer pot, the area including below and around the circumference of the inner sieve.

6. The container of claim 1 wherein the inner sieve is further comprised of lower slats projecting downwardly from an underside of the inner sieve, the lower slats cooperating with a base of the outer pot to provide separation between the outer pot and inner sieve.

7. The container of claim 1 wherein the inner sieve is further comprised of upper slats projecting downwardly from a rim of the inner sieve, the upper slats cooperating with a circumferential wall of the outer pot to provide separation and proper alignment between the outer pot and inner sieve.

8. The container of claim 1 wherein a rim of the inner sieve is comprised of a peripheral edge, the peripheral edge configured to sit in a stepped portion of a lip of the outer pot.

9. The container of claim 1 wherein the outer pot is further comprised of drainage holes to allow the egress of excess water from the container.

10. The container of claim 1 wherein the inner sieve is further comprised of a central body having an underside, the central body and underside further comprised of holes to permit roots of the plant to escape into the channel.

11. The container of claim 1 wherein the inner sieve is further comprised of a central body having an underside, the central body and underside further comprised of screens to expose roots abutting the screens to be pruned by air flowing in the channel.

12. A container comprising:
an outer pot;
an inner sieve removably positioned in the outer pot, the inner sieve to contain plants and growing medium; and,
a saucer connected to one of: the outer pot and the inner sieve, the saucer to contain water,
wherein the outer pot, inner sieve and saucer define a channel through which air can flow to prune roots of the plant and growing medium.

13. The container of claim 12 further comprising a plurality of upper apertures positioned at an upper end of the channel and lower apertures positioned at a lower end of the channel, whereby air flows through the lower and upper apertures and into the channel.

14. The container of claim 13 wherein the lower apertures are positioned along one of: a circumferential wall of the outer pot and an underside of the outer pot, and the upper apertures are positioned along one of: the circumferential wall of the outer pot and a rim of the inner sieve.

15. The container of claim 13 wherein the channel is an area in between the inner sieve and the outer pot, the area including below and around the circumference of the inner sieve.

16. The container of claim 12 wherein the inner sieve is further comprised of:
lower slats projecting downwardly from an underside of the inner sieve, the lower slats cooperating with a base of the outer pot to provide separation between the outer pot and inner sieve; and,
upper slats projecting downwardly from a rim of the inner sieve, the upper slats cooperating with a circumferential wall of the outer pot to provide separation and proper alignment between the outer pot and inner sieve.

17. The container of claim 12 wherein a rim of the inner sieve is comprised of a peripheral edge, the peripheral edge configured to sit in a stepped portion of a lip of the outer pot.

18. The container of claim 12 wherein the outer pot is further comprised of drainage holes to allow the egress of water from the container.

19. The container of claim 12 wherein the outer pot has a pot base, the pot base further comprised of an opening.

20. The container of claim 19 wherein the inner sieve is further comprised of a lower body projecting downwardly from an underside of the sieve, the lower body configured to fit through the opening and sit in the saucer.

21. The container of claim 19 wherein the lower body is comprised of openings to receive the substances contained within the saucer.

22. The container of claim 12 wherein the saucer is further comprised of at least one rib to reduce water sloshing in the saucer.

23. The container of claim 12 wherein the saucer has a plurality of posts projecting from a base of the saucer, the plurality of posts terminating in clips to secure the saucer to the outer pot.

24. The container of claim 23 wherein the outer pot is further comprised of receiving openings to receive and lock the clips.

25. The container of claim 24 wherein the receiving openings are funnel-shaped to self-align the saucer to the outer pot.

26. The container of claim 23 wherein the clips flare outwardly and are configured to flex inwardly.

27. The container of claim 12 wherein the saucer is further comprised of at least one float restrictedly moveable within a casing.

28. The container of claim 27 wherein the casing is pivotable from a first flat position to a second upright position, the flat position for storage and transportation of the container.

29. The container of claim 28 wherein the casing is comprised of a lower notch and a front notch, the lower notch to lock the casing in the second upright position, and the front notch to lock the casing in the first flat position.

30. The container of claim 27 wherein the float is comprised of a flare-out and the casing is comprised of a corresponding flare-in, the flare-out and flare-in to lock the float within the casing.
